(19) United States
(12) Patent Application Publication
(10) Pub. No.: US 2026/0149604 A1
(43) Pub. Date: May 28, 2026

(54) DESIGNATION OF A TRUSTED ENTITY IN A DATA SPACE

(71) Applicant: Orange, Issy-Les-Moulineaux (FR)

(72) Inventors: Gaël FROMENTOUX, Chatillon Cedex (FR); Frédéric FIEAU, Chatillon Cedex (FR)

(21) Appl. No.: 19/120,641

(22) PCT Filed: Oct. 11, 2023
(86) PCT No.: PCT/EP2023/078133

§ 371 Date: Apr. 11, 2025

(30) Foreign Application Priority Data
Oct. 14, 2022 (FR) FR2210583

(51) Int. Cl. H04L 9/32

(52) U.S. Cl. CPC H04L 9/3268

(57) ABSTRACT

A method of registration of a certification entity of a data space for at least one target criterion associated with a service, the method being implemented by a data space management entity capable of managing the certification entity. The method includes: receiving self-description data from a candidate for certification entity status for the data space for the at least one target criterion, the candidate being capable of certifying at least one criterion of a service; and registering the candidate in a registry specific to the data space, as a certification entity of the data space for the at least one target criterion in the event that, based on the self-description data, the candidate is determined to be capable of verifying the conformity of the at least one target criterion with the service.

### CROSS-REFERENCE TO RELATED APPLICATIONS

This application filed under 35 U.S.C. § 371 as the U.S. National Phase of Application No. PCT/EP2023/078133 entitled “DESIGNATION OF A TRUSTED ENTITY IN A DATA SPACE” and filed Oct. 11, 2023, and which claims priority to FR 2210583 filed Oct. 14, 2022, each of which is incorporated by reference in its entirety.

### BACKGROUND

### Field

This disclosure relates to the field of data spaces. More particularly, this disclosure relates to methods for designating a certification entity of a data space and the associated management entities, data spaces, and communications networks.

### Description of the Related Technology

It is known to share data within data exchange spaces. However, current data sharing technologies are non-transparent and non-interoperable, and do not guarantee a trusted environment.

In light of this observation, the European Union has launched an initiative called “GAIA-X”, to design and then create a new generation of target data infrastructures for Europe, its businesses, and its citizens. The target infrastructure, also called a data space, aims to be the cradle of an ecosystem where data and services based on this data are available, collected, and shared in a trusted environment where digital sovereignty is exercised. In particular, the target infrastructure is supported by a federation of computer networks, also called clouds, operated by different operators. Certification entities, or “trust anchors”, are responsible for verifying that the deployment of a service is in compliance with a predefined compliance description, by ensuring that the resources of participants that will support the service are indeed compliant with pre-established rules and standards and can therefore be certified and registered as such.

However, a given certification entity is not necessarily capable of validating a particular resource. There is therefore a need, when knowing the particular resource, to identify a certification entity capable of validating that particular resource of an infrastructure.

### SUMMARY

A method is thus proposed for the designation of a certification entity of a data space for at least one target criterion associated with a predetermined service over a region, the method being implemented by a management entity of the data space that is capable of managing the certification entity of the data space, and comprising: receiving self-description data from a candidate for certification entity status for the data space for the at least one target criterion associated with the predetermined service over the region, the candidate being capable of certifying at least one criterion of a service implemented in the region of the data space; verifying, based on the self-description data, whether the candidate is further capable of verifying compliance with the at least one target criterion associated with the predetermined service over the region; if it is so capable, registering said candidate in a registry specific to the data space, as a certification entity of the data space for the at least one target criterion associated with the service over the region.

Advantageously, with this method, a mechanism for searching for, and then designating, a certification entity for the at least one target criterion can be obtained.

Knowing that different certification entities may be used to certify characteristics of a resource for a given service, it is possible that, for the deployment of a service, a plurality of certification entities may be required for the different resources contributing to the service may be required. The method makes it possible to limit the number of certification entities to a region, such as a region of jurisdiction of a data space (territory, country, geographical region), and to determine the certification entities capable of certifying a characteristic (location, network technology, security, etc.) of a resource for a given service. The method for designation makes it possible to ensure that the services implemented in a data space on the basis of resources are trusted, due to the designation of trusted certification entities in accordance with the method for designation.

The features set forth in the following paragraphs may optionally be implemented, independently of one another or in combination with one another:

According to one or more embodiments, the method further comprises: sending a certification entity certificate to the certification entity of the data space for the at least one target criterion associated with the predetermined service over the region; indexing the certification entity of the data space for the target criterion associated with the predetermined service over the region, in a service catalog of the data space.

According to one or more embodiments, the candidate for certification entity status is capable of certifying at least one resource, and the self-description data are chosen from a group comprising an element among: a certification of the resource by an authority of the data space, a use of the resource, a location of the resource, or a combination of elements of the group.

According to one or more embodiments, the method further comprises: determining the existence or non-existence of at least one data space authority certification entity in a service catalog of the data space for the predetermined service over the region; and when the non-existence of at least one data space authority certification entity is determined for the predetermined service over the region of the data space, the method further comprises: registering, in the registry specific to the data space, the certification entity of the data space for the at least one target criterion associated with the predetermined service over the region, as a data space authority certification entity for the predetermined service over the region, adding the data space authority certification entity to the service catalog of the data space for the predetermined service over the region.

According to one or more embodiments, when the existence of at least one data space authority certification entity is determined for the predetermined service over the region of the data space, the method further comprises: sending the information regarding the candidate for certification entity status to the data space authority certification entity; wherein the determination of the compliance of the candidate for certification entity status is carried out by the data space authority certification entity.

According to one or more embodiments, a certification entity status of the certification entity of the data space for the target criterion for the predetermined service over the region is stored with a network data analytics function and/or the management entity.

According to another aspect, a management entity of the data space is provided, the management entity being capable of managing a certification entity of the data space for at least one target criterion associated with a predetermined service over a region, and being configured for: receiving self-description data from a candidate for certification entity status for the data space for the at least one target criterion associated with the predetermined service over the region, the candidate being capable of certifying at least one criterion of a service implemented in the region of the data space; verifying, based on the self-description data, whether the candidate is further capable of verifying compliance with the at least one target criterion associated with the predetermined service over the region; if it is so capable, registering said candidate in a registry specific to the data space, as a certification entity of the data space for the at least one target criterion associated with the service over the region.

According to another aspect, a data space of a communications network is provided, the data space comprising a management entity of the data space according to the present description and a service catalog for the service over the region, wherein the management entity is configured for: sending a certification entity certificate to the certification entity of the data space, for the at least one target criterion associated with the service over the region; indexing the certification entity of the data space for the target criterion associated with the predetermined service over the region, in the service catalog of the data space.

According to one or more embodiments, the data space comprises a management entity according to the present description and a service catalog for the predetermined service over the region, wherein the management entity is configured for: determining the existence or non-existence of at least one data space authority certification entity in the service catalog; wherein, when the non-existence of at least one data space authority certification entity is determined for the predetermined service over the region of the data space, the management entity is further configured for: registering, in the registry specific to the data space, the certification entity of the data space for the at least one target criterion associated with the predetermined service over the region, as a data space authority certification entity for the predetermined service over the region, adding the data space authority certification entity to the service catalog.

According to one or more embodiments, the data space comprises a management entity according to the present disclosure. The management entity assigns an authority certification entity status to certain candidate third-party entities. The authority certification entity status (of the data space for the at least one target criterion associated with the predetermined service over the region) is then stored with a network data analytics function and/or the management entity.

According to another aspect, a communications network is provided comprising a data space according to the present disclosure, wherein, when the existence of at least one data space authority certification entity is determined for the service over the region of the data space, the management entity is further configured for:
sending the information regarding the certification entity candidate to the data space authority certification entity;
and the determination of the compliance of the candidate for certification entity status is carried out by the data space authority certification entity.

According to another aspect, a computer program is provided comprising instructions for implementing all or part of a method as defined herein when such program is executed by a processor. According to another aspect, a non-transitory, computer-readable storage medium is provided on which such a program is stored.

### BRIEF DESCRIPTION OF THE DRAWINGS

Other features, details and advantages will become apparent from reading the detailed description below, and from analyzing the attached drawings, in which:

FIG. 1 shows an exemplary architecture of network functions designated as certification entities according to one embodiment.

FIG. 2 shows an exemplary method for the designation of a certification entity according to one embodiment.

FIG. 3 shows an example of verifying the ability of a candidate to verify compliance with at least one target criterion associated with a predetermined service over a region, according to one embodiment.

FIG. 4 shows an example of deploying a service over a region of the data space according to one embodiment.

### DETAILED DESCRIPTION OF CERTAIN ILLUSTRATIVE EMBODIMENTS

In the various figures, the same references designate identical or similar elements.

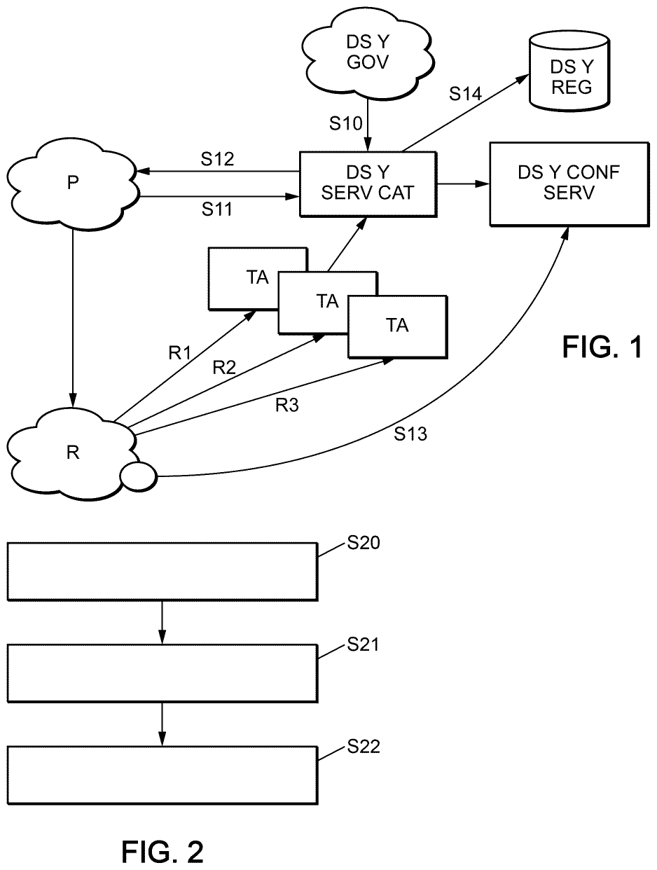

FIG. 1 shows an exemplary architecture of network functions, denoted TA, designated as certification entities of the data space denoted DS Y.

According to one or more embodiments, data space DS Y is associated with a field of activity. The field of activity relates, in certain non-limiting examples, to telecommunications, finance, health, or agricultural services.

The governance, denoted DS Y GOV, for data space DS Y contacts the authority in charge of the field of activity, in order to obtain a list of reference certifiers. According to one or more embodiments, the authorities differ depending on the characteristics of data space DS Y. For example, the authorities differ depending on the field of activity of data space DS Y and/or its geographical coverage. According to one non-limiting example, the French Cybersecurity Agency (ANSSI) may be chosen to be the authority in charge of the telecommunications field of activity for the geographical region corresponding to France.

In a step S10, governance DS Y GOV for data space DS Y defines parameters necessary for the certification of resources, denoted R, R1, R2, R3, of one or more participants, denoted P, in data space DS Y. Participants P are suppliers of resources R, R1, R2, R3. Resources R, R1, R2, R3 may for example be data, network links, software, or clouds. The resources may also correspond to management functions of a network or service.

The parameters required for the certification of resources R, R1, R2, R3 are compiled in a certified catalog function, denoted DS Y SERV CAT.

In order to guarantee the compliance of resources R, R1, R2, R3 with the compliance descriptions of data space DS Y, data space DS Y relies on certification entities TA. The certification entities TA may be provided by participants P during a step S11. Certification entities TA are, for example, control devices, for example located at an edge of data space DS Y. The control devices are, for example, orchestrators.

Certification entities TA are capable of verifying at least one criterion of a service implemented in data space DS Y. In particular, certification entities TA may act as certifiers to verify compliance and may then sign parameters from a self-signed description, or SSD, of resources R, R1, R2, R3. Furthermore, certification entities TA may act as certifiers to verify and sign an identity and/or resources R, R1, R2, R3.

In a step S12, one or more participants P, or even each of participants P, receives one or more addresses of certification entities TA capable of certifying at least one criterion of a service implemented in data space DS Y.

Resources R1, R2, R3 submit their parameters from the self-signed description to one or more, or even each, of certification entities TA whose addresses were received in step S12. Each certification entity TA may verify and then certify some or all of the parameters from the self-signed description. Thus, depending on the parameters and the certification entities TA, a single certification entity TA or several complementary certification entities TA may be necessary for the certification of a resource. Indeed, a certification entity TA may be specialized and certify one or more parameters from the self-signed description. For example, a certification entity TA may verify parameters relating to the identification of a resource, or parameters relating to compatibility with a telecommunications standard, or parameters related to a value-added service.

When a resource is certified by a certification entity TA, for example resource R2 in FIG. 1, the parameters from the self-signed description are presented during a step S13 to the compliance service, denoted DS Y CONF SERV, of data space Y. Furthermore, in a step S14, the certified resource is registered in the service registry, denoted DS Y REG, of data space DS Y. Certified resource R2 may then be used by participants P to support the services of data space DS Y.

FIG. 2 shows an example of a method for the designation of a certification entity TA of data space DS Y for at least one target criterion associated with a predetermined service, denoted service_i in FIG. 4, over a region.

The region may be defined as a geographical territory over which governance DS Y GOV has legal control and/or a recognized reputation. It may be a particular geographical region of the data space, such as a country or a region covering several countries. It may also be a region defined according to legal liability when the data space extends over several jurisdictions. It may also be a region delimited by a technology, for example in the context of a multi-technology or multi-domain data space, for example in the case of a multi-AS (“Autonomous Systems”) data space. According to one example, the region corresponds to data space DS Y. A region may correspond to a cooperation agreement, and/or a recognized reputation may be subject to a set of rules in a field or to legal control. As an example, a consortium of partners-for example, parties in the health sector and/or in industry-who wish to exchange data agree on the conditions for exchanging this data while complying with business law relating to their field, for example via a cooperation agreement specific to the region, and to do so makes technical use of data space DS Y. In some cases, labeling is implemented so as to be governed only by the legalities in force over the region, for example European legislation, and not by an off-shore influence such as American legislation specific to another region of the data space for example.

In a first step, denoted S20, self-description data of a candidate (or certification entity candidate) for certification entity status in data space DS Y for the at least one target criterion associated with predetermined service service_i over the region are received. The candidate is capable of certifying at least one criterion of a service implemented in the region of data space DS Y.

In a second step, denoted S21, it is verified, based on the self-description data, whether or not the candidate is also capable of verifying compliance with the at least one target criterion associated with predetermined service service_i over the region.

In a third step, denoted S22, when the candidate is deemed suitable in step S21, the candidate is registered in registry DS Y REG as a certification entity of data space DS Y for the at least one target criterion associated with service service_i over the region.

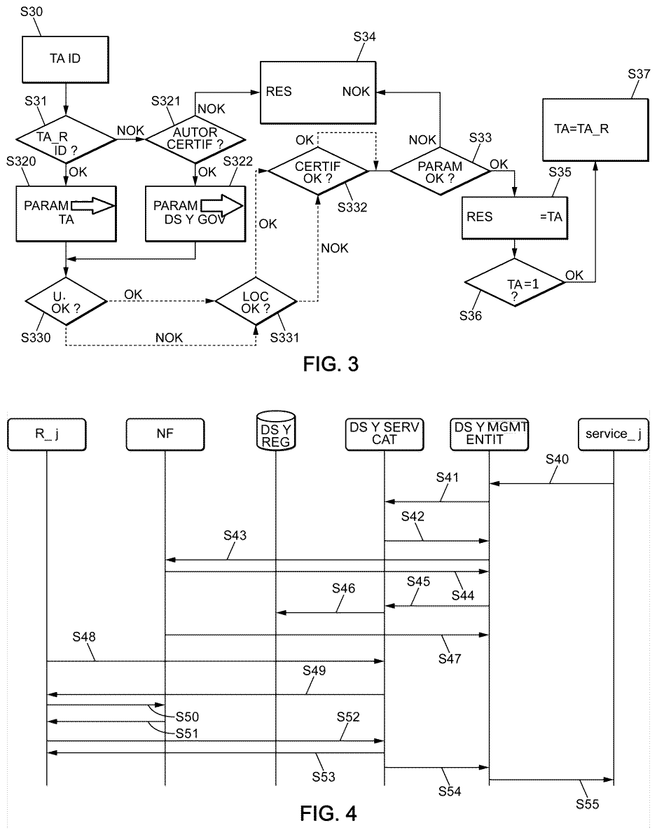

FIG. 3 shows an example of verifying the candidate's ability to verify compliance with the at least one target criterion associated with predetermined service service_i over the region.

Verification of the candidate's ability to verify compliance with the at least one target criterion associated with predetermined service service_i over the region may be implemented by a management entity, denoted DS Y MGMT ENTIT in FIG. 4.

The management entity may for example be an operation support system, or OSS, a business support system, or BSS, or an authority certification entity, denoted TA_R in FIG. 3, of the data space.

In a step S30, one or more data space authority certification entities TA_R may be identified from service catalog DS Y CAT SERV of data space DS Y, for predetermined service service_i over the region. Additionally, participants P in the field may be identified from service catalog DS Y CAT SERV.

In a step S31, the existence or non-existence of at least one data space authority certification entity TA_R may be determined based on the identification in step S30. An authority certification entity is, for example, an entity designated by a control entity of the data space, the entity being capable of certifying at least one parameter of a service_i and further being capable of delegating the certification of a resource to a certification entity designated for one or more parameters. In particular, when no data space authority certification entity TA_R is identified in step S30, the non-existence of at least one data space authority certification entity TA_R can be confirmed. Conversely, when at least one data space authority certification entity TA_R is identified in step S30, the existence of at least one data space authority certification entity TA_R can be confirmed.

When the non-existence of at least one data space authority certification entity TA_R is determined in step S31 (arrow “NOK” exiting step S31 in FIG. 3), the candidate may be evaluated for certification in a step S321. The certification evaluated may be certification by an authority of data space DS Y.

When the candidate is not certified by the authority (arrow “NOK” exiting step S321), the candidate is deemed non-compliant with data space DS Y in a step S34. In this case, the candidate is then not designated as a certification entity TA of data space DS Y for the target criterion associated with predetermined service service_i over the region.

When the candidate is certified by the authority (arrow “OK” exiting step S321), self-description data of the candidate are sent to governance DS Y GOV for data space DS Y.

Alternatively, when the existence of at least one data space authority certification entity TA_R is identified in step S31 (arrow “OK” exiting step S31), self-description data of the candidate are sent to the at least one data space authority certification entity TA_R of data space DS Y. In addition, the self-description data of the candidate may be sent to participants P identified during step S30 over the region.

The self-description data of the candidate may comprise one or more elements chosen from a group comprising an element among: a certification of the resource by an authority of the data space, a use of the resource, a location of the resource, or a combination of elements of the group.

The implementation of steps S33, S330, S331, S332 aims to verify, based on the self-description data, whether the candidate is indeed capable of verifying compliance with the at least one target criterion associated with predetermined service service_i over the region. Step S33 may be implemented individually or in combination with one or more of steps S330, S331, S332.

Step S33 aims to verify whether the candidate's parameters are compliant with data space DS Y. According to one or more embodiments, the candidate is deemed to be compliant with data space DS Y only if each of the parameters is compliant (arrow “OK” exiting step S33).

According to one or more embodiments, during step S330, whether the use of the candidate is compliant may be evaluated. Use of the candidate may for example correspond to the candidate's intended purpose for public or private use. According to one non-limiting example, use of the candidate may correspond to use by a company.

According to one or more embodiments, during step S331, the candidate's location may be evaluated. According to one or more embodiments, the evaluation of the candidate's location may depend on the use. According to one non-limiting example, the candidate's location may be deemed compliant if the candidate is located within the European Union.

According to one or more embodiments, during step S332, a certification of the network and/or of the security of the candidate by a data space authority may be evaluated. The evaluation of the certification of the network and/or of the security of the candidate may comprise one or more elements in a group comprising an element among: an ANSSI certification, a standard of the European Telecommunications Standards Institute, a standard of the International Organization for Standardization ISO, or a combination of elements of the group.

When the candidate parameters are not deemed to be compliant in step S33 (arrow “NOK” exiting step S33), the candidate is deemed to be non-compliant in data space DS Y in a step S34. In this case, the candidate is then not designated as a certification entity TA of data space DS Y for the target criterion associated with predetermined service service_i over the region.

Alternatively, when the candidate parameters are deemed to be compliant in step S33 (arrow “OK” exiting step S33), the candidate is then designated as a certification entity TA of data space DS Y for the target criterion associated with predetermined service service_i over the region, in a step S35. The candidate, now designated as a certification entity TA of data space DS Y for the target criterion associated with predetermined service service_i over the region, receives a certification entity certificate. In addition, certification entity TA designated for the target criterion associated with predetermined service service_i over the region is indexed in service catalog DS Y SERV CAT of data space DS Y. Additionally, the newly designated certification entity TA for the target criterion associated with predetermined service service_i over the region is added to service registry DS Y REG of data space DS Y.

In a step S36, the presence of other certification entities TA (other than the newly designated one) in the domain may be evaluated. When the certification entity TA designated for the target criterion associated with predetermined service service_i over the region is the only certification entity TA in the domain (arrow “OK” exiting step S36), certification entity TA designated for the target criterion associated with predetermined service service_i over the region may be updated in service registry DS Y REG of data space DS Y as data space authority certification entity TA_R for predetermined service service_i over the region (step S37).

FIG. 4 shows an example deployment of predetermined service service_i over the region of data space DS Y.

In a step S40, the provider of service_i requests support for service_i by data space DS Y, with criteria, over the region. The criteria are, for example, criteria such as fault, configuration, accounting, performance, security, or FCAPS.

In a step S41, management entity DS Y MGMT ENTIT asks the service catalog function DS Y SERV CAT whether there are candidates capable of certifying at least one criterion of a service implemented in the region of data space DS Y. The candidates may comprise one or more network functions, denoted NF. Network functions NF may validate different criteria, for example such as identity and location.

Furthermore, management entity DS Y MGMT ENTIT asks participants P whether they have resources, denoted R_j, to support service_i.

In a step S42, the service catalog function DS Y SERV CAT responds to management entity DS Y MGMT ENTIT.

According to one or more embodiments, the response from management entity DS Y MGMT ENTIT comprises an identity of a manager of a candidate. In some cases, the manager is a participant P of data space DS Y. According to one or more embodiments, the response from management entity DS Y MGMT ENTIT may comprise a certificate and an address of a network function NF of a candidate.

In a step S43, management entity DS Y MGMT ENTIT evaluates the ability of network function NF to verify compliance with at least one target criterion associated with predetermined service service_i over the region. This evaluation may in particular be done as described with reference to FIG. 3.

If the candidate's network function NF is verified as having this ability in step S43, the candidate is designated as a certification entity TA of data space DS Y for the at least one target criterion associated with predetermined service service_i over the region. All or part of the steps described below may then be implemented.

In a step S44, designated certification entity TA receives a certification entity certificate.

In a step S45, management entity DS Y MGMT ENTIT indexes designated certification entity TA in service catalog DS Y SERV CAT of data space DS Y.

In a step S46, management entity DS Y MGMT ENTIT registers designated certification entity TA in registry DS Y REG specific to data space DS Y as a certification entity TA of data space DS Y for the at least one target criterion associated with service service_i over the region.

In a step S47, the certification entity certificate is announced to data space DS Y. According to one or more embodiments, the certification entity certificate is announced to data space DS Y by a protocol referred to as the Border Gateway Protocol, BGP. The certification entity certificate may in particular be announced via trusted network links. In particular, according to one non-limiting example, the trusted network links may be Industrial Data space communication Secure Protocol (IDSP) links, within the framework of a data space as defined in GAIA-X.

Furthermore, according to one or more embodiments, a certification entity status of certification entity TA of data space DS Y for the at least one target criterion associated with predetermined service service_i over the region is stored with a Network Data Analytics Function NWDAF and/or management entity DS Y MGMT ENTIT. “Stored with” is understood here to mean that the information is stored in a manner accessible to said entities.

The network data analytics function makes it possible in particular to collect data relating to a user, to network function NF, or to a maintenance and management function. According to one or more embodiments, data are transmitted between the two parties, with the participant for example performing the 5G functions (NF, NWDAF), and the data space (DS Y) operator (OSS/BSS), via a Network Exposition Function NEF.

In a step S48, the resource or a manager of the resource R_j of participant P asks service catalog function DS Y SERV CAT to validate resource R_j. Resource R_j is for example a connector (link, device, network function, etc.).

In a step S49, service catalog function DS Y SERV CAT provides the address or addresses of the designated certification entity or entities TA in order to validate resource R_j in region Z for data space DS Y. Each designated certification entity TA comprises one or more network functions NF which can validate different but complementary required criteria for a service_i, such as the identity, location, use, certifications of the resource. In particular, data space DS Y provides the addresses of designated certification entities TA for service service_i.

In a step S50, resource R_j presents its self-signed description to network function NF for a validation request by certification entity TA. In the example of FIG. 4, certification entity TA is for example an orchestrator, possibly located at an edge of the data space.

In a step S51, the self-signed description is signed with the certification entity certificate from network function NF and its private key. Optionally, the self-signed description is hashed and/or time-stamped.

In a step S52, the self-signed description is presented to compliance service DS Y CONF SERV of service catalog DS Y SERV CAT.

In a step S53, the self-signed description is signed by compliance service DS Y CONF SERV and is registered for data space DS Y in service catalog DS Y SERV CAT.

In a step S54, resource R_j is registered by data space DS Y.

In a step S55, management entity DS Y MGMT ENTIT sends the response to the provider of service service_i: service_i is supported by data space DS Y over region Z.

Thus, the methods described above make it possible to efficiently identify a certification entity TA of data space DS Y for at least one target criterion associated with predetermined service service_i over the region. Furthermore, for the same target criterion associated with another service, certification entity TA may be pre-selected as a candidate, to further increase the efficiency of identifying certification entities TA in data space DS Y.

1. A method of registration of a certification entity of a data space for at least one target criterion associated with a service, the method being implemented by a management entity of the data space that is capable of managing the certification entity of the data space and comprising:
receiving self-description data from a candidate for certification entity status for the data space for the at least one target criterion associated with the service, the candidate being capable of certifying at least one criterion of a service; and
registering the candidate in a registry specific to the data space, as a certification entity of the data space for the at least one target criterion associated with the service in the event that, based on the self-description data, the candidate is determined to be capable of verifying the conformity of the at least one target criterion with the service.

2. The method according to claim 1, which further comprises:
sending a certification entity certificate to the certification entity of the data space for the at least one target criterion associated with the service; and
indexing the certification entity of the data space for the target criterion associated with the service, in a service catalog of the data space.

3. The method according to claim 1, wherein the candidate for certification entity status is capable of certifying at least one resource, and wherein the self-description data are chosen from a group comprising an element among:
a certification of the resource by an authority of the data space, a use of the resource, a location of the resource, or a combination of elements of the group.

4. The method according to claim 3, the method further comprising:
determining the existence or non-existence of at least one data space authority certification entity in a service catalog of the data space for the service;
wherein, when the non-existence of at least one data space authority certification entity (TA_R) is determined for the service of the data space the method further comprises:
registering, in the registry specific to the data space-(DS the certification entity of the data space for the at least one target criterion associated with the service, as a data space authority certification entity for the service, and
adding the data space authority certification entity to the service catalog of the data space for the service.

5. The method according to claim 4, wherein, when the existence of at least one data space authority certification entity is determined for the service of the data space (DS Y), the method further comprises:
sending the information regarding the candidate for certification entity status to the data space authority certification entity;
wherein the determination of the compliance of the candidate for certification entity status is carried out by the data space authority certification entity.

6. The method according to claim 1, wherein a certification entity status of the certification entity of the data space for the at least one target criterion associated with the service is stored with a network data analytics function and/or the management entity.

7. A management entity of a data space, the management entity being capable of managing a certification entity of the data space for at least one target criterion associated with a service, and being configured to:
receive self-description data from a candidate for certification entity status for the data space for the at least one target criterion associated with the service, the candidate being capable of certifying at least one criterion of a service implemented in the data space;
verify, based on the self-description data, whether the candidate is further capable of verifying compliance with the at least one target criterion associated with the service; and
if it is so capable, registering the candidate in a registry specific to the data space as a certification entity of the data space for the at least one target criterion associated with the service.

8. A data space of a communications network, the data space comprising a management entity of the data space according to claim 7 and a service catalog for the service, wherein the management entity is configured to:
send a certification entity certificate to the certification entity of the data space (DS Y) for the at least one target criterion associated with the service (service_i) over the region; and
index the certification entity of the data space for the target criterion associated with the service, in the service catalog of the data space.

9. A data space of a communications network, the data space comprising a management entity according to claim 7 and a service catalog for the predetermined service, wherein the management entity is configured to:
determine the existence or non-existence of at least one data space authority certification entity in the service catalog;
wherein, when the non-existence of at least one data space authority certification entity is determined for the service of the data space the management entity is further configured for to:
register, in the registry specific to the data space, the certification entity of the data space for the at least one target criterion associated with the service, as a data space authority certification entity for the service, and
add the data space authority certification entity to the service catalog.

10. A data space of a communications network, the data space comprising a management entity according to claim 7, wherein a certification entity status of the certification entity of the data space for the at least one target criterion associated with the service is stored with a network data analytics function and/or the management entity.

11. A communications network comprising a data space according to claim 9, wherein, when the existence of at least one data space authority certification entity is determined for the service of the data space the management entity is further configured to:
send the information about the certification entity candidate to the data space authority certification entity;
wherein the determination of the compliance of the candidate for certification entity status is carried out by the data space authority certification entity.

12. A processing circuit comprising a processor and a memory, the memory storing program code instructions of a computer program to execute the method according to claim 1 when this computer program is executed by the processor.

13. A non-transitory computer-readable storage medium on which is stored a computer program for implementing the method according to claim 1 when this computer program is executed by a processor.
